(19) United States
(12) Patent Application Publication
(10) Pub. No.: US 2026/0081903 A1
(43) Pub. Date: Mar. 19, 2026

(54) METHOD AND SYSTEM FOR AUTHENTICATING AUTONOMOUS AGENT COMMUNICATIONS

(71) Applicant: JPMorgan Chase Bank, N.A., New York, NY (US)

(72) Inventors: Venkata Mohit TAMANAMPUDI, New Castle, DE (US); Jayaprakash MOSES, Greenville, DE (US); Ravi KURUGANTHY, Frisco, TX (US)

(73) Assignee: JPMorgan Chase Bank, N.A., New York, NY (US)

(21) Appl. No.: 18/927,032

(22) Filed: Oct. 25, 2024

Related U.S. Application Data
(60) Provisional application No. 63/696,733, filed on Sep. 19, 2024.

(51) Int. Cl. H04L 9/40

(52) U.S. Cl. CPC H04L 63/08; H04L 2463/082

(57) ABSTRACT

A method and a system for authenticating autonomous agent communications are provided. The method includes: receiving a request to transmit information from a first autonomous artificial intelligence (AI) agent to a second autonomous AI agent; generating a first authentication factor for the second autonomous AI agent; analyzing the first authentication factor to determine whether an identity of the second autonomous AI agent is verifiable; and when the determination is made that the identity of the second autonomous AI agent is verifiable, transmitting the information from the first autonomous AI agent to the second autonomous AI agent.

### CROSS-REFERENCE TO RELATED APPLICATION

This application claims the benefit from U.S. Provisional Application No. 63/696,733, filed Sep. 19, 2024, which is hereby incorporated by reference in its entirety.

### BACKGROUND

### 1. Field of the Disclosure

This technology generally relates to methods and systems for authenticating autonomous agent communications, and more particularly to methods and systems for ensuring authenticity and integrity of communications and interactions between autonomous agents.

### 2. Background Information

As artificial intelligence (AI)-driven systems become more prevalent, autonomous agents are increasingly responsible for performing complex tasks, often in coordination with other agents. These tasks require secure and reliable communication channels. Traditional methods like passwords, Application Programming Interface (API) keys, and open authorization (OAuth) tokens have been used for authentication in various systems. However, these methods are not sufficient for the unique demands of AI agent communication.

The key challenges include: 1) Scalability Issues: traditional methods struggle to scale effectively in environments with numerous interacting AI agents. 2) Lack of Mutual Authentication: many existing methods only authenticate one side of the communication, leaving the system vulnerable to impersonation attacks. 3) Vulnerability to Attacks: methods such as passwords and API keys are susceptible to phishing, brute-force, and man-in-the-middle (MitM) attacks.

Additionally, the rapid proliferation of AI systems across critical sectors such as finance, healthcare, and defense has necessitated secure communication and authentication protocols between AI agents. Traditional authentication methods, such as public-key cryptography and password-based systems, are increasingly vulnerable to attacks, particularly in distributed and interconnected environments where sensitive data is transmitted across multiple nodes.

These traditional methods require the exchange of sensitive information (e.g., keys and passwords) during the authentication process, making them susceptible to interception, MitM attacks, and replay attacks. Additionally, these methods often lack scalability and impose significant computational overhead, which can be a bottleneck in large-scale AI systems. The challenge lies in finding an authentication method that is both secure and efficient, and that protects the privacy of the agents involved.

Existing authentication methods include: 1) Public-Key Cryptography: public-key cryptography is widely used for securing communications, but it requires the exchange of public keys, which can be intercepted. The security of these systems also heavily relies on the secrecy of private keys, making them vulnerable to certain types of attacks. 2) Password-Based Authentication: passwords are a common method of authentication, but they are susceptible to brute-force attacks and phishing. Even with hashed passwords, the transmission of password hashes can be intercepted, leading to potential security breaches. 3) Token-Based Authentication: token-based systems rely on the secure storage and transmission of tokens. While effective, these systems are vulnerable to token theft, and their scalability is limited by the need to manage and distribute tokens securely.

The traditional authentication methods have several vulnerabilities. MitM attacks, replay attacks, and phishing remain significant threats, particularly in distributed systems where multiple points of failure exist. Traditional methods struggle to scale efficiently in environments with a large number of interacting agents. The computational overhead associated with key management, encryption, and decryption can be prohibitive as system complexity increases. The resource-intensive nature of encryption and key management in public-key systems imposes a significant burden on both the computational and networking resources of large-scale AI systems.

Passwords and API keys may be simple to implement and widely used but are vulnerable to phishing, brute-force attacks, and lack mutual authentication. They also require manual management, which can lead to human error. OAuth Tokens may provide delegated access and more security than passwords, but token management is complex, there are lifecycle challenges, and they lack mutual authentication.

The current authentication mechanisms are inadequate for securing the communication between autonomous AI agents. These methods fail to provide the necessary security guarantees, such as mutual authentication, encryption, and scalability. Without robust authentication, AI agents are vulnerable to malicious attacks, which can lead to data breaches, unauthorized access, and compromised decision-making processes.

Accordingly, there is a need for ensuring authenticity and integrity of communications and interactions between autonomous agents.

### SUMMARY

The present disclosure, through one or more of its various aspects, embodiments, and/or specific features or sub-components, provides, inter alia, various systems, servers, devices, methods, media, programs, and platforms for ensuring authenticity and integrity of communications and interactions between autonomous agents. According to an aspect of the present disclosure, a method for authenticating autonomous agent communications is provided. The method may be implemented by at least one processor. The method may include: receiving, by the at least one processor, a request to transmit information from a first autonomous artificial intelligence (AI) agent to a second autonomous AI agent; generating, by the at least one processor, a first authentication factor for the second autonomous AI agent; analyzing, by the at least one processor, the first authentication factor to determine whether an identity of the second autonomous AI agent is verifiable; and when the determination is made that the identity of the second autonomous AI agent is verifiable, transmitting, by the at least one processor, the information from the first autonomous AI agent to the second autonomous AI agent.

The method may further include: generating, by the at least one processor, a second authentication factor for the first autonomous AI agent, by issuing, via a certificate authority, a first certificate that includes a first public key and first identifying information of the first autonomous AI agent, the generating of the first authentication factor comprises issuing, by the at least one processor via the certificate authority, a second certificate that includes a second public key and second identifying information of the second autonomous AI agent; and analyzing, by the at least one processor, the second authentication factor to determine whether an identity of the second autonomous AI agent is verifiable. The analyzing of the second authentication factor comprises exchanging the first certificate with the second autonomous AI agent and determining, by the at least one processor via the certificate authority, whether the first certificate is valid. And the analyzing of the first authentication factor comprises exchanging the second certificate with the first autonomous AI agent and determining, by the at least one processor via the certificate authority, whether the second certificate is valid.

The method may further include: verifying, by the at least one processor via the certificate authority, a revocation status of the first certificate based on a certificate revocation list; when the revocation status of the first certificate is listed as revoked, preventing, by the at least one processor, the transmitting of the information from the first autonomous AI agent to the second autonomous AI agent; verifying, by the at least one processor via the certificate authority, a revocation status of the second certificate based on the certificate revocation list; and when the revocation status of the second certificate is listed as revoked, preventing, by the at least one processor, the transmitting of the information from the first autonomous AI agent to the second autonomous AI agent.

The method may further include: determining, by the at least one processor, whether the first certificate is compromised; when the first certificate is compromised, generating, by the at least one processor, a revocation request; transmitting, by the at least one processor, the revocation request to the certificate authority; determining, by the at least one processor, whether the second certificate is compromised; when the second certificate is compromised, generating, by the at least one processor, a revocation request; and transmitting, by the at least one processor, the revocation request to the certificate authority.

The method may further include: changing, by the at least one processor, the first public key at a predetermined interval; and changing, by the at least one processor, the second public key at the predetermined interval.

The method may further include: the generating of the first authentication factor may include generating, by the at least one processor, a zero-knowledge proof, and the analyzing of the first authentication factor may comprise: transmitting, by the at least one processor, a challenge to the second autonomous AI agent; prompting, by the at least one processor, the second autonomous AI agent to compute a response to the challenge; and prompting, by the at least one processor, the first autonomous AI agent to determine whether the computed response matches a key based on the generated zero-knowledge proof.

The method may further include: generating, by the at least one processor via a master AI agent, the zero-knowledge proof using a zero-knowledge proof protocol engine; and transmitting, by the at least one processor, the zero-knowledge proof from the master AI agent to the first autonomous AI agent.

The analyzing of the first authentication factor may further include: generating, by the at least one processor via a cryptographic hash function, the challenge; and prompting, by the at least one processor, the second autonomous AI agent to compute a commitment proof, wherein the computation of the response to the challenge is based on the commitment proof.

The analyzing of the first authentication factor may further include: prompting, by the at least one processor, the second autonomous AI agent to select a first random value and compute a commitment proof based on the first random value; transmitting, by the at least one processor, the challenge from the first autonomous AI agent to the second autonomous AI agent; prompting, by the at least one processor, the second autonomous AI agent to compute the response to the challenge based on the commitment proof; and transmitting, by the at least one processor, the response from the second autonomous AI agent to the first autonomous AI agent for the determining of whether the computed response matches the key based on the generated zero-knowledge proof.

According to another aspect of the present disclosure, a computing apparatus for authenticating autonomous agent communications is provided. The computing apparatus may include a processor; a memory; and a communication interface coupled to each of the processor, and the memory. The processor may be configured to: receive, via the communication interface, a request to transmit information from a first autonomous AI agent to a second autonomous AI agent; generate a first authentication factor for the second autonomous AI agent; analyze the first authentication factor to determine whether an identity of the second autonomous AI agent is verifiable; and when the determination is made that the identity of the second autonomous AI agent is verifiable, transmit the information from the first autonomous AI agent to the second autonomous AI agent.

The processor may be further configured to: generate a second authentication factor for the first autonomous AI agent; issue, via a certificate authority, a first certificate that includes a first public key and first identifying information of the first autonomous AI agent; issue, via the certificate authority, a second certificate that includes a second public key and second identifying information of the second autonomous AI agent; and analyze the second authentication factor to determine whether an identity of the second autonomous AI agent is verifiable. The analysis of the second authentication factor may include exchanging the first certificate with the second autonomous AI agent and determining, via the certificate authority, whether the first certificate is valid. And the analysis of the first authentication factor may include exchanging the second certificate with the first autonomous AI agent and determining, via the certificate authority, whether the second certificate is valid.

The processor may be further configured to: verify, via the certificate authority, a revocation status of the first certificate based on a certificate revocation list; when the revocation status of the first certificate is listed as revoked, prevent the transmitting of the information from the first autonomous AI agent to the second autonomous AI agent; verify, via the certificate authority, a revocation status of the second certificate based on the certificate revocation list; and when the revocation status of the second certificate is listed as revoked, prevent the transmitting of the information from the first autonomous AI agent to the second autonomous AI agent.

The processor may be further configured to: determine whether the first certificate is compromised; when the first certificate is compromised, generate a revocation request; transmit the revocation request to the certificate authority; determine whether the second certificate is compromised; when the second certificate is compromised, generate a revocation request; and transmit the revocation request to the certificate authority.

The processor may be further configured to: change the first public key at a predetermined interval; and change the second public key at the predetermined interval.

The processor may be further configured to: generate a zero-knowledge proof; transmit a challenge to the second autonomous AI agent; prompt the second autonomous AI agent to compute a response to the challenge; and prompt the first autonomous AI agent to determine whether the computed response matches a key based on the generated zero-knowledge proof.

The processor may be further configured to: generate, via a master AI agent, the zero-knowledge proof using a zero-knowledge proof protocol engine; and transmit the zero-knowledge proof from the master AI agent to the first autonomous AI agent.

The processor may be further configured to: generate, via a cryptographic hash function, the challenge; and prompt the second autonomous AI agent to compute a commitment proof, wherein the computation of the response to the challenge is based on the commitment proof.

The processor may be further configured to: prompt the second autonomous AI agent to select a first random value and compute a commitment proof based on the first random value; transmit the challenge from the first autonomous AI agent to the second autonomous AI agent; prompt the second autonomous AI agent to compute the response to the challenge based on the commitment proof; and transmit the response from the second autonomous AI agent to the first autonomous AI agent for the determining of whether the computed response matches the key based on the generated zero-knowledge proof.

According to yet another aspect of the present disclosure, a non-transitory computer readable storage medium storing instructions for authenticating autonomous agent communications is provided. The storage medium includes executable code which, when executed by a processor, may cause the processor to: receive a request to transmit information from a first autonomous artificial intelligence (AI) agent to a second autonomous AI agent; generate a first authentication factor for the second autonomous AI agent; analyze the first authentication factor to determine whether an identity of the second autonomous AI agent is verifiable; and when the determination is made that the identity of the second autonomous AI agent is verifiable, transmit the information from the first autonomous AI agent to the second autonomous AI agent.

The executable code may further cause the processor to: generate a second authentication factor for the first autonomous AI agent; issue, via a certificate authority, a first certificate that includes a first public key and first identifying information of the first autonomous AI agent; issue, via the certificate authority, a second certificate that includes a second public key and second identifying information of the second autonomous AI agent; and analyze the second authentication factor to determine whether an identity of the second autonomous AI agent is verifiable. The analysis of the second authentication factor may include exchanging the first certificate with the second autonomous AI agent and determining, via the certificate authority, whether the first certificate is valid. And the analysis of the first authentication factor may include exchanging the second certificate with the first autonomous AI agent and determining, via the certificate authority, whether the second certificate is valid.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for ensuring authenticity and integrity of communications and interactions between autonomous agents, according to an embodiment.

FIG. 2 illustrates a diagram of a network environment for ensuring authenticity and integrity of communications and interactions between autonomous agents, according to an embodiment.

FIG. 3 illustrates a system diagram of a system for ensuring authenticity and integrity of communications and interactions between autonomous agents, according to an embodiment.

FIG. 4 illustrates a process diagram of a process for ensuring authenticity and integrity of communications and interactions between autonomous agents, according to an embodiment.

FIG. 5 illustrates a certificate issuance flow diagram for ensuring authenticity and integrity of communications and interactions between autonomous agents, according to an embodiment.

FIG. 6 illustrates an authentication flow diagram for ensuring authenticity and integrity of communications and interactions between autonomous agents, according to an embodiment.

FIG. 7 illustrates a system architectural diagram for ensuring authenticity and integrity of communications and interactions between autonomous agents, according to an embodiment.

FIG. 8 illustrates a zero-knowledge proof authentication flow diagram for ensuring authenticity and integrity of communications and interactions between autonomous agents, according to an embodiment.

FIG. 9 illustrates a zero-knowledge proof process diagram for ensuring authenticity and integrity of communications and interactions between autonomous agents, according to an embodiment.

FIG. 10 illustrates a zero-knowledge proof architecture diagram for ensuring authenticity and integrity of communications and interactions between autonomous agents, according to an embodiment.

FIG. 11 illustrates a non-interactive zero-knowledge proof flow diagram for ensuring authenticity and integrity of communications and interactions between autonomous agents, according to an embodiment.

FIG. 12 illustrates a multi-agent zero-knowledge proof authentication flow diagram for ensuring authenticity and integrity of communications and interactions between autonomous agents, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units and/or modules of the example embodiments may be physically combined into more complex blocks, units, and/or modules without departing from the scope of the present disclosure.

A system or method disclosed herein improves security, integrity, and trust in communications between AI agents. Particularly, the system receives a request for sensitive information to be transmitted between AI agents. The recipient AI agent then generates a mechanism that is used for authentication. The system then analyzes the authentication mechanism to determine if the recipient AI agent can be verified and trusted. Once the recipient AI agent is verified the sensitive information may be transmitted from the transmitting AI agent to the recipient AI agent. According to an embodiment, the system may use AI agents, a Certificate Authority (CA), and a Public Key Infrastructure (PKI) for issuing, renewing, and revoking certificates, and the AI agents use these certificates to authenticate and establish secure communication channels. By implementing certificate-based authentication, the system addresses key security challenges such as impersonation, data tampering, and unauthorized access. In some embodiments, the recipient AI agent may first commit to a value, receive a challenge from the transmitting AI agent, and then responds in a way that the recipient AI agent can verify without learning the transmitting AI agent's secret. By implanting this value-based authentication, the system allows for authentication without the need to exchange or reveal sensitive data. By not transmitting secrets during the authentication process, the system is resistant to many types of attacks. Additionally, the system may be applied to large-scale networks of AI agents, making it suitable for complex, distributed AI systems. Moreover, verifiers do not need to trust the prover with sensitive information, reducing the risk of data leaks.

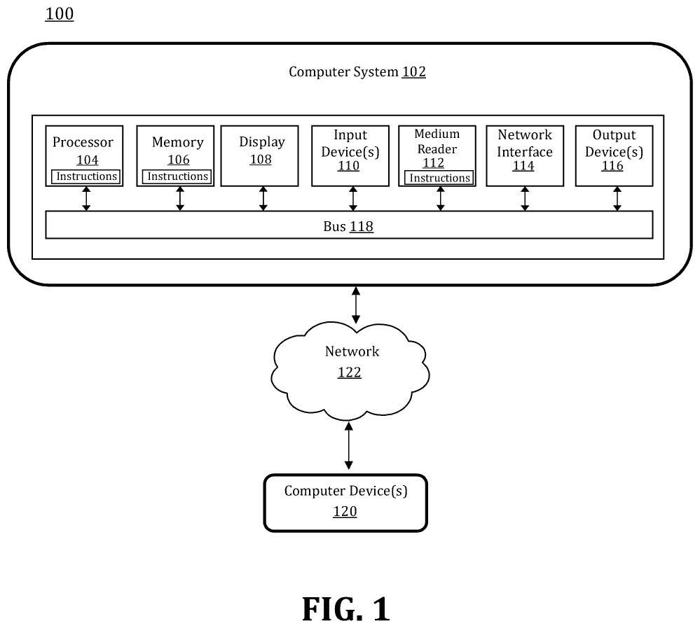

FIG. 1 is a system 100 for ensuring authenticity and integrity of communications and interactions between autonomous agents, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the authentication module implemented by the system 100 may allow for ensuring authenticity and integrity of communications and interactions between autonomous agents. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

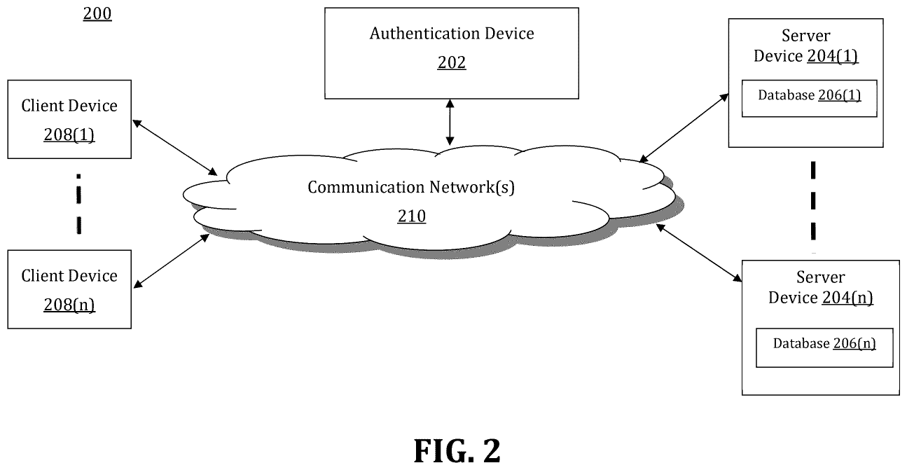

Referring to FIG. 2, a schematic of a network environment 200 for ensuring authenticity and integrity of communications and interactions between autonomous agents is illustrated.

In some embodiments, the above-described problems associated with conventional tools may be overcome by implementing an authentication device 202 as illustrated in FIG. 2 that may be configured for ensuring authenticity and integrity of communications and interactions between autonomous agents, but the disclosure is not limited thereto.

The authentication device 202 may include one or more computer systems 102, as described with respect to FIG. 1, which in aggregate provide the necessary functions.

The authentication device 202 may store one or more applications that can include executable instructions that, when executed by the authentication device 202, cause the authentication device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the authentication device 202 itself, may be located in virtual server(s) running in a cloud-based computing environment rather than being tied to one or more specific physical network computing devices. Also, the application(s) may be running in one or more virtual machines (VMs) executing on the authentication device 202. Additionally, in one or more embodiments of this technology, virtual machine(s) running on the authentication device 202 may be managed or supervised by a hypervisor.

In the network environment 200 of FIG. 2, the authentication device 202 may be coupled to a plurality of server devices 204(1)-204(n) that hosts a plurality of databases 206(1)-206(n), and also to a plurality of client devices 208(1)-208(n) via communication network(s) 210. A communication interface of the authentication device 202, such as the network interface 114 of the computer system 102 of FIG. 1, operatively couples and communicates between the authentication device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the authentication device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The authentication device 202 may be a standalone device or integrated with one or more other devices or apparatuses, such as one or more of the server devices 204(1)-204(n), for example. In one example, the authentication device 202 may be hosted by one of the server devices 204(1)-204(n), and other arrangements are also possible. Moreover, one or more of the devices of the authentication device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the authentication device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the authentication device 202 that may ensure authenticity and integrity of communications and interactions between autonomous agents, but the disclosure is not limited thereto.

The client devices 208(1)-208(n) may run interface applications, such as standard web browsers or standalone client applications, which may provide an interface to communicate with the authentication device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the authentication device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the authentication device 202, the server devices 204(1)-204(n), or the client devices 208(1)-208(n), for example, may be configured to operate as virtual instances on the same physical machine. For example, one or more of the authentication devices 202, the server devices 204(1)-204(n), or the client devices 208(1)-208(n) may operate on the same physical device rather than as separate devices communicating through communication network(s) 210. Additionally, there may be more or fewer authentication devices 202, server devices 204(1)-204(n), or client devices 208(1)-208(n) than illustrated in FIG. 2. In some embodiments, the authentication device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

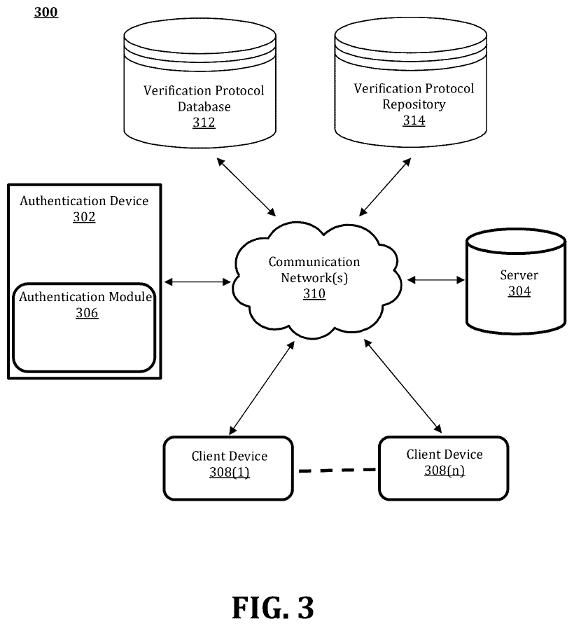

FIG. 3 illustrates a system diagram for ensuring authenticity and integrity of communications and interactions between autonomous agents in accordance with an embodiment.

As illustrated in FIG. 3, the system 300 may include an authentication device 302 within which an authentication module 306 is embedded, a server 304, a verification protocol database 312, a verification protocol repository 314, a plurality of client devices 308(1) . . . 308(n), and a communication network 310.

In some embodiments, the authentication device 302 including the authentication module 306 may be connected to the server 304, the verification protocol database 312, and the verification protocol repository 314 via the communication network 310. The authentication device 302 may also be connected to the plurality of client devices 308(1) . . . 308(n) via the communication network 310, but the disclosure is not limited thereto. The verification protocol database 312 and the verification protocol repository 314 may include one or more repositories or databases.

In an embodiment, the authentication device 302 is described and shown in FIG. 3 as including the authentication module 306, although it may include other rules, policies, modules, databases, or applications, for example. In some embodiments, the verification protocol database 312 and the verification protocol repository 314 may be configured to store ready to use modules written for each API for all environments. Although only one database and one repository are illustrated in FIG. 3, the disclosure is not limited thereto. Any number of desired databases and/or repositories may be utilized for use in the disclosed invention herein. The verification protocol database 312 and the verification protocol repository 314 may be a mainframe database, a log database that may produce programming for searching, monitoring, and analyzing machine-generated data via a web interface, but the disclosure is not limited thereto. In addition, the verification protocol database 312 and the verification protocol repository 314 may store a plurality of data sets and predictive models for authenticating autonomous agents.

In some embodiments, the authentication module 306 may be configured to receive real-time feed of data from the plurality of client devices 308(1) . . . 308(n) and secondary sources via the communication network 310.

The authentication module 306 may be configured to: receive a request to transmit information from a first autonomous AI agent to a second autonomous AI agent; generate a first authentication factor for the second autonomous AI agent; analyze the first authentication factor to determine whether an identity of the second autonomous AI agent is verifiable; and when the identity of the second autonomous AI agent is verifiable, transmitting the information from the first autonomous AI agent to the second autonomous AI agent.

The plurality of client devices 308(1) . . . 308(n) are illustrated as being in communication with the authentication device 302. In this regard, the plurality of client devices 308(1) . . . 308(n) may be “clients” (e.g., customers) of the authentication device 302 and are described herein as such. Nevertheless, it is to be known and understood that the plurality of client devices 308(1) . . . 308(n) need not necessarily be “clients” of the authentication device 302, or any entity described in association therewith herein. Any additional or alternative relationship may exist between either or both plurality of client devices 308(1) . . . 308(n) and the authentication device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the authentication device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The authentication device 302 may be the same or similar to the authentication device 202 as described with respect to FIG. 2, including any features or combination of features described with respect thereto.

Upon being started, the authentication device 302 executes a process for ensuring authenticity and integrity of communications and interactions between autonomous agents.

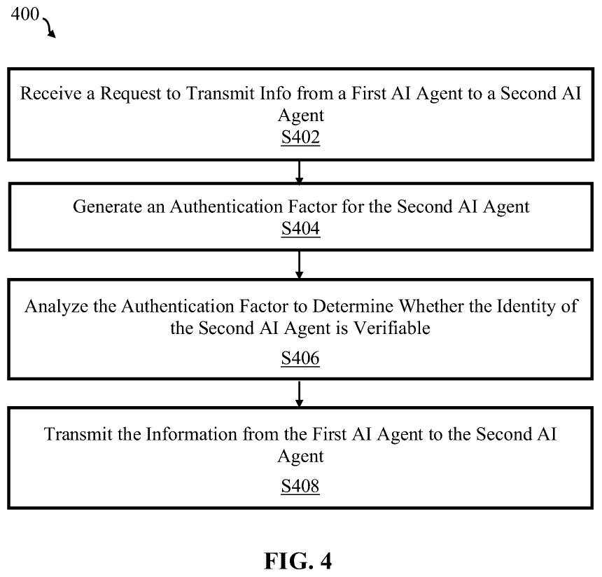

FIG. 4 illustrates a process 400 for ensuring authenticity and integrity of communications and interactions between autonomous agents, according to an embodiment.

In process 400 of FIG. 4, at step S402, the authentication device 302 may be configured to receive a request to transmit information from a first autonomous AI agent to a second autonomous AI agent. In some embodiments, the request may be for the AI agents to interact with each other to exchange data, perform collaborative tasks, or coordinate actions. In an embodiment, the information may be sensitive information and the request to transmit the information may be a request for a secure exchange or transmission of the sensitive information.

At step S404, the authentication device 302 may be configured to generate an authentication factor for the second autonomous agent. In some embodiments, the authentication factor may be one selected from among a certificate-based factor, a PKI-based factor, and a cryptographic-based factor. The certificate-based factor may use encrypted certificates for securing web communications between AI agents. The certificate-based factor may ensure that both the client and server are authenticated. The PKI-based factor may use digital certificates to verify the identities of various AI agents for authentication. The PKI-based factor may be used for managing digital certificates in enterprise environments, to ensure secure communication between users, devices, and services. The cryptographic-based factor may allow one party (the prover) to prove to another (the verifier) that a statement is true without revealing any other information for authentication.

In some embodiments, the certificate-based factor and/or the PKI-based factor for the generating of the authentication factor for the second autonomous agent may include using a CA to issue a certificate that includes a public key and identifying information of the second autonomous AI agent. In an embodiment, the authentication device 302 may also be configured to generate an authentication factor for the first autonomous AI agent. The generating of the second authentication factor may include using the CA to issue a certificate that includes a public key and identifying information of the first autonomous AI agent.

In an embodiment, the cryptographic-based factor for the generating of the first authentication factor may include generating a zero-knowledge proof. The zero-knowledge proof may be a cryptographic method that enables one party to prove knowledge of a value to another party without revealing any information about the value itself. According to an embodiment, the zero-knowledge proof may satisfy three properties for authentication: 1) Completeness: if the statement is true, an honest verifier will be convinced by an honest prover. 2) Soundness: if the statement is false, a dishonest prover cannot convince the verifier of its truth, except with a negligible probability. 3) Zero-Knowledge: the verifier learns nothing beyond the fact that the statement is true. The zero-knowledge proof may include at least one from among an interactive protocol and a non-interactive protocol. In the interactive protocol, there may be multiple rounds of communication between the prover and verifier. The prover may generate a proof that the verifier checks across several exchanges. The non-interactive protocol eliminates the need for back-and-forth communication and may use a cryptographic hash function to generate the challenge. The prover may create a proof that may be verified by anyone at any time.

At step S406, the authentication device 302 may be configured to analyze the authentication factor for the second autonomous AI agent to determine whether the identity of the second autonomous AI agent can be verified. The verification of the second autonomous agent may depend on the type of authentication factor employed by the authentication device 302.

In an embodiment, the analyzing of the authentication factor for the second autonomous AI agent may include exchanging the certificate of the second autonomous AI agent with the first autonomous AI agent. The authentication device 302 may then be configured to use the CA to determine whether the certificate of the second autonomous AI agent is valid. The authentication device 302 may also be configured to analyze the authentication factor of the first autonomous AI agent to determine whether the identity of the first autonomous AI agent can be verified. The analyzing of the authentication factor for the first autonomous AI agent may include exchanging the certificate of the first autonomous AI agent with the second autonomous AI agent. The authentication device 302 may then be configured to use the CA to determine whether the certificate of the first autonomous AI agent is valid.

In some embodiments, the analyzing of the authentication factor for the second autonomous AI agent may include the second autonomous AI agent receiving a challenge, the second autonomous AI agent computing a response to the challenge based on the generated zero-knowledge proof, and the first autonomous AI agent determining whether the computed response matches a key. In an embodiment, the second autonomous AI agent may first commit to a value, receive a challenge from the first autonomous AI agent, and then respond in a way that the first autonomous AI agent can verify without learning the second autonomous AI agent's secret. In some embodiments, the second autonomous AI agent may generate the zero-knowledge proof without requiring real-time interaction with the first autonomous AI agent. The second autonomous AI agent may use a cryptographic hash function to generate the challenge.

Then, at step S408, if the identity of the second autonomous AI agent is verified, the authentication device 302 may be configured to transmit the requested information from the first autonomous AI agent to the second autonomous AI agent. In some embodiments, if the identity of the first autonomous AI agent is verified, the authentication device 302 may be configured to transmit the requested information from the second autonomous AI agent to the first autonomous AI agent.

In an embodiment, the authentication device 302 may be configured to leverage digital certificates for authenticating AI agents, providing a scalable, secure, and trustworthy communication system. A digital certificate is an electronic document that uses a digital signature to bind a public key with an identity. The certificate may be issued by a trusted CA and contains the public key and identity details of the AI agent. Types of certificate-based authentication in other domains include web security (e.g., HTTPS), which use SSL/TLS certificates for securing web communication to ensure that both the client and server are authenticated, and enterprise systems, which use PKI for managing digital certificates in enterprise environments, ensuring secure communication between users, devices, and services. PKI is a framework for managing digital certificates and public-key encryption. It ensures secure electronic transfer of information, authenticates the identity of the communicating parties, and encrypts the data exchanged. The authentication device 302 may use digital certificates by applying PKI to AI agent communication, enabling mutual authentication, encryption, and non-repudiation. The authentication device 302 may be configured to be scalable, making it suitable for environments with a large number of interacting AI agents. Unlike existing methods, the authentication device 302 may not be limited to specific use cases and may be applied broadly across various AI-driven domains.

In some embodiments, the authentication device 302 may be configured to implement certificate-based authentication to address key security challenges such as impersonation, data tampering, and unauthorized access. The authentication device 302 may also be configured to provide a foundation for future research in secure AI agent communication, particularly in exploring its integration with emerging AI communication protocols.

In some embodiments, the authentication device 302 may be configured to implement multiple mechanisms for security analysis including: 1) Threat Modeling: the system's resilience against potential attacks is analyzed, including scenarios such as replay attacks, MitM attacks, and brute-force attacks. The ZKP protocol's ability to mitigate these threats is evaluated. And 2) Performance Metrics: the proposed system's security is assessed using metrics such as the probability of a false positive (incorrectly verifying a non-authentic agent) and resistance to common attack vectors. These metrics are crucial in determining the system's robustness.

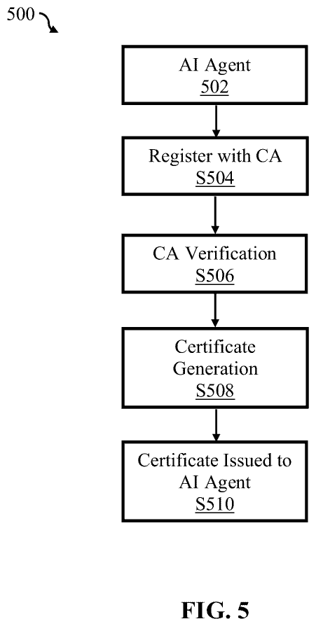

FIG. 5 illustrates a certificate issuance flow diagram 500 for ensuring authenticity and integrity of communications and interactions between autonomous agents, according to an embodiment. Particularly, the certificate issuance flow diagram 500 illustrates the process of certificate issuance. The diagram 500 includes an AI agent 502, a register with the CA step S504, a CA verification step S506, a certificate generation step S508, and a certificate issued to AI agent 502 step S510.

Particularly, as illustrated by flow diagram 500, at step S504 the AI agent 502 registers with a CA by providing a requested proof of identity and a public key. The CA then validates the AI agent 502 at step S506, based on the proof of identity. Next, at step S508, the CA generates a certificate for the AI agent 502. The certificate may be a digital certificate that bind's the AI agent's 502 identity to its public key. Then, at step S510, the certificate is issued/distributed to the AI agent 502.

In an embodiment, the authentication device 302 may include several key components including: 1) Certificate Issuance: AI agents may register with a trusted CA, which verifies their identity and issues a digital certificate containing the agent's public key; 2) Authentication Process: AI agents may exchange and validate digital certificates before establishing communication. The process involves verifying the CA's signature, ensuring that only authenticated agents can communicate; 3) Key Exchange and Secure Communication: upon successful authentication, AI agents may perform a key exchange to establish an encrypted communication session, ensuring data integrity and confidentiality.

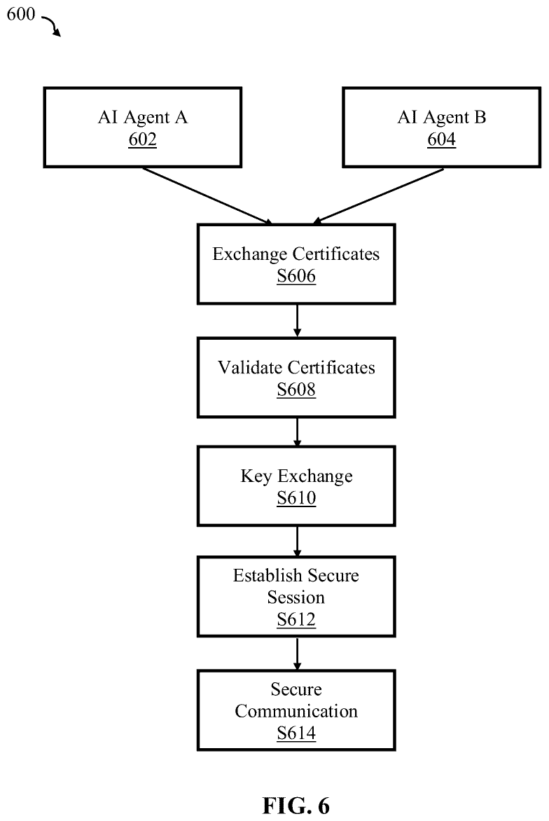

FIG. 6 illustrates an authentication flow diagram 600 for ensuring authenticity and integrity of communications and interactions between autonomous agents, according to an embodiment. Particularly, the authentication flow diagram 600 depicts the authentication process between to AI Agents, particularly AI agent A 602 and AI agent B 604. The diagram 600 includes an exchanging of certificates step S606, a validate certificates step S608, key exchange step S610, an establish secure session step S612, and a secure communication step S614.

Particularly, as illustrated by flow diagram 600, AI agent A 602 and AI agent B 604 want to communicate with each other (e.g., for the exchanging or transmitting of tasks and/or data). At step S606, AI agent A 602 and AI agent B 604 exchange their digital certificates. At step S608, each AI agent validates the received certificate with the CA. Next, at step S610, each AI agent exchanges their validated public keys and establishes a secure session at step S612. Then, at step S614, a secure communication is established between AI agent A 602 and AI agent B 604, allowing for encrypted data to be exchanged over a secure session.

In an embodiment, the authentication process implemented by the authentication device 302 may include: 1) Certificate Issuance: each AI agent is issued a digital certificate by a trusted CA. The certificate includes the agent's public key and identifying information. 2) Certificate Exchange: when two AI agents initiate communication, they exchange their digital certificates. 3) Validation: each AI agent validates the received certificate with the issuing CA to ensure its authenticity. 4) Session Establishment: upon successful validation, the AI agents establish a secure communication session using their private keys and the exchanged public keys. In some embodiments, trust and validation may be improved through several elements including: Reliability: using certificates from a trusted CA establishes a chain of trust, ensuring that only legitimate AI agents can participate in communication; and Accountability: each AI agent's identity is verified, providing a mechanism to trace actions back to specific agents.

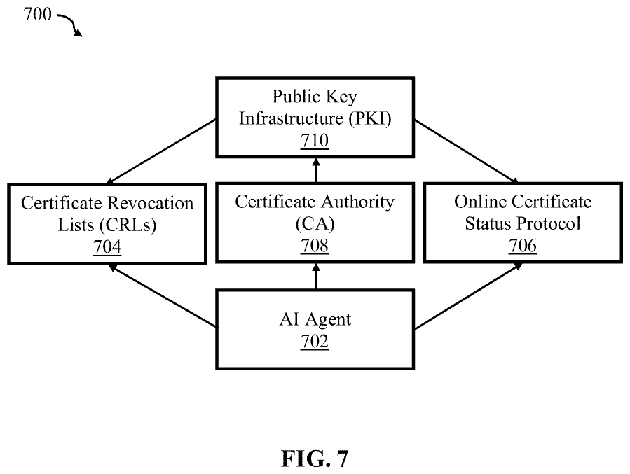

FIG. 7 illustrates a system architectural diagram 700 for ensuring authenticity and integrity of communications and interactions between autonomous agents, according to an embodiment. Particularly, the system architectural diagram 700 illustrates the overall system and includes AI Agent 702, certificate revocation lists (CRLs) 704, online certificate status protocol (OCSP) 706, the CA 708, and the PKI 710.

Particularly, as illustrated by the system architectural diagram 700, the AI agent 702 may check the CRLs 704 and query the OCSP 706 to determine the revocation status of a certificate before establishing communication with another AI agent. Additionally, as shown by flow diagram 700, if a certificate is compromised, the AI agent 702 may send a revocation request to the CA, which then uses the PKI to update the CRL 704 and distribute the update to the OCSP 706. Thus, the system architectural diagram 700 illustrates interaction between the overall system for handling revocation requests and for ensuring authenticity and integrity of communications and interactions between autonomous agents.

In some embodiments, the architecture of the authentication device 302 may include AI agents, a CA, and a PKI. The CA may be responsible for issuing, renewing, and revoking certificates, while AI agents may use these certificates to authenticate and establish secure communication channels. In an embodiment, source code (e.g., Python) may be used for setting up and using digital certificates to secure communication between AI agents. Additionally, the source code may be used for validating the digital certificates received from other AI agents.

Regarding Security Considerations the authentication device 302 may be configured for: 1) Robust Key Management: the authentication device 302 may secure storage of private keys, regular key rotation, and automated renewal of certificates. Regularly rotating keys reduces the risk of key compromise. Private keys are stored in secure hardware modules (HSMs) for secure storage; 2) Continuous Monitoring and Revocation: the authentication device 302 may support continuous monitoring of certificate validity and enable quick revocation in case of compromise. The CA regularly updates CRLs, and agents can check certificate status using the OCSP. The authentication device 302 may monitor communication patterns to detect and prevent anomalous activities and maintain logs of all authentication events for forensic analysis. 3) Compliance with Security Standards: the authentication device 302 may adhere to industry standards for certificate management, including X.509 for certificates and Transport Layer Security (TLS) for secure communication. The authentication device 302 may also adhere to regulatory requirements for data protection and privacy. Additionally, CRLs and OCSP may be used to manage and check the validity of certificates, ensuring that compromised or expired certificates are not used. Moreover, the authentication device 302 may include several elements for enhancing security including: 1) Mutual Authentication: both AI agents authenticate each other, ensuring that communication is established only between trusted entities; 2) Data Integrity: the use of digital signatures ensures that data cannot be altered during transmission; and 3) Encryption: public-key encryption secures the data exchanged between AI agents.

The authentication device 302 may improve security measures through several protocols including: 1) Mutual Authentication: both the client and server authenticate each other, ensuring that communication is established only between trusted entities. This is more robust compared to methods like passwords or API keys, which typically involve only one-way authentication. And 2) Encryption: digital certificates facilitate the use of public-key cryptography, which may provide secure encryption of data. This ensures that the data exchanged between AI agents remains confidential and cannot be intercepted or tampered with.

The authentication device 302 may improve data integrity through Digital Signatures: certificates use digital signatures to verify the integrity of the data. This ensures that the data has not been altered during transmission, which is a significant advantage over simpler methods like basic HTTP authentication or API keys that do not provide data integrity checks.

The authentication device 302 may improve scalability through several mechanisms including: 1) Centralized Management: PKI allows for centralized management of certificates, making it easier to issue, renew, and revoke certificates. This is more scalable than managing a large number of passwords or API keys, which can become cumbersome and error prone. And 2) Automated Processes: processes such as certificate issuance, renewal, and revocation can be automated, reducing the administrative overhead and the potential for human error.

The authentication device 302 may improve trust and accountability through several mechanisms including: 1) Chain of Trust: certificates from a trusted CA establish a chain of trust, ensuring that only legitimate AI agents can participate in communication. This is more reliable than methods that do not involve a trusted third party. And 2) Audit Trails: digital certificates provide a mechanism to trace actions back to specific agents, which is useful for auditing and forensic analysis. This level of accountability is harder to achieve with methods like shared passwords or API keys.

The authentication device 302 may improve revocation capabilities through CRL and OCSP: certificates may be revoked if compromised, and the status may be checked using CRLs or the OCSP. This is a distinct advantage over methods like static passwords or API keys, which often lack a straightforward mechanism for revocation without disrupting service.

The authentication device 302 may improve compliance with standards protocols through a regulatory compliance mechanism: using certificates helps in adhering to regulatory requirements for data protection and privacy. Standards like X.509 for certificates and TLS for secure communication are widely recognized and ensure a high level of security compliance.

The authentication device 302 may improve resilience against common attacks including: 1) Phishing Resistance: certificates are less susceptible to phishing attacks compared to password-based methods. Since certificates are not easily shared or communicated like passwords, it reduces the risk of them being phished. 2) MitM Attack Prevention: mutual authentication and encrypted communication help prevent MitM attacks, which can be a risk with simpler authentication mechanisms.

The authentication device 302 may improve user experience through Transparent Authentication: once set up, certificate-based authentication can operate transparently in the background, providing a seamless experience for users and AI agents. This is more convenient than requiring frequent password changes or managing multiple API keys.

In some embodiments, the authentication device 302 may implement several mechanisms for issuing certificates including: 1) Registration: the AI agent registers with a CA, providing necessary identity proof and public key; 2) Verification: the CA verifies the identity of the AI agent; 3) Certificate Generation: the CA generates a digital certificate binding the AI agent's identity to its public key; and 4) Distribution: the digital certificate is issued to the AI agent.

In an embodiment, the authentication device 302 may implement several mechanisms for workflow authentication including: 1) Initialization: manager agent wants to communicate with a first task/AI agent and second task/AI agent; 2) Certificate Exchange: all agents exchange their digital certificates; 3) Validation: each agent validates the received certificate with the CA; 4) Key Exchange: using the validated public keys, all agents perform a key exchange to establish a secure session; and 5) Secure Communication: encrypted data is exchanged over the secure session.

In an embodiment, the authentication device 302 may implement several mechanisms for revocation handling including: 1) Revocation Request: if a certificate is compromised, a revocation request is sent to the CA; 2) CRL Update: the CA updates the CRL and distributes it to all entities; and 3) OCSP Query: AI agents query the OCSP to check the revocation status of a certificate before establishing communication.

In a test scenario, AI agents were required to authenticate each other using digital certificates before exchanging data. In the test scenario, the System Configuration included: Processor: Intel Xeon Gold 6138 (2.0 GHZ, 20 cores); RAM: 256 GB; Operating System: Ubuntu 20.04 long-term support (LTS); Network: 1 Gbps Ethernet. And, in the test scenario, the software included: Python version: 3.8; SSL/TLS Library: OpenSSL 1.1.1; and AI Agents: Simulated using lightweight Python microservices deployed on Docker containers.

The test scenario measured the time taken to complete the following steps: 1) Certificate Exchange; 2) Certificate Validation; 3) Key Exchange; and 4) Secure Data Transmission. In the test scenario, the average time for each step was: Certificate Exchange: 10.5 ms; Certificate Validation: 15.3 ms; Key Exchange (TLS Handshake): 20.7 ms; Secure Data Transmission (1 KB): 2.1 ms; and Total Latency per Transaction: 48.6 ms. Thus, the total latency introduced by the certificate-based authentication process was approximately 48.6 milliseconds per transaction. This latency is considered minimal and acceptable for most real-time AI agent communication scenarios. The overhead introduced by certificate validation and key exchange is necessary to ensure security, and the results indicate that the framework is suitable for high-speed AI environments.

Additionally, in the test scenario, the CPU utilization during the certificate-based authentication process was measured, focusing on the key exchange and encryption/decryption phases. In the test scenario, the CPU utilization percentage for each step was: Certificate Exchange: 3.5%; Certificate Validation: 5.2%; Key Exchange: 8.9%; and Secure Data Transmission: 1.3%. The memory overhead introduced by the framework was also measured, particularly during the certificate handling and cryptographic operations. In the test scenario, the memory usage for each step was: Certificate Exchange: 20.5 MB; Certificate Validation: 35.7 MB; Key Exchange: 42.3 MB; and Secure Data Transmission: 15.4 MB. Thus, the authentication device 302 introduces a modest increase in CPU utilization and memory usage, primarily during the key exchange phase. However, the overhead remains within acceptable limits for modern server-grade hardware, ensuring that the authentication device 302 can be deployed without significant performance degradation.

In a test scenario using simulated attacks, the effectiveness of the authentication device 302 in mitigating key security threats, including impersonation, data tampering, and unauthorized access was evaluated. The simulated attacks include: 1) Impersonation Attack: an unauthorized agent attempts to pose as a legitimate agent by submitting a forged certificate; 2) MitM Attack: an adversary intercepts communication between two agents and attempts to alter the transmitted data; and 3) Replay Attack: an adversary captures a legitimate communication session and attempts to replay it to gain unauthorized access. In the test scenario, the mitigation success rate for each attack type: Impersonation attack: 100%; MitM Attack: 99.7%; and Replay Attack: 100%. Thus, the authentication device 302 successfully mitigates impersonation and replay attacks in all the tested scenarios. The near-perfect mitigation of MitM attacks (99.7%) demonstrates the robustness of the encryption and key exchange processes. The slight variance in MitM mitigation may result from the network latency and timing of key exchanges but is negligible in practical terms.

In a test scenario, the scalability of the authentication device 302 by simulating many AI agents interacting concurrently was assessed. In the test scenario, a certificate is revoked by the CA, and AI agents must verify the revocation status before initiating communication. The time taken to retrieve and process CRLs and OCSP responses was measured. In the test scenario, the average response times for CRLs and OCSP were 12.3 milliseconds and 7.9 milliseconds, respectively. Thus, these results indicate that the framework can promptly detect and respond to revoked certificates, maintaining high levels of security in real-time communication scenarios. In an embodiment, the authentication device 302 may implement several elements for improving scalability including: Centralized Management: PKI allows for centralized management of certificates, making it easier to issue, renew, and revoke certificates; and Interoperability: standardized protocols and certificates enable seamless communication across different platforms and systems.

In a test scenario, the effectiveness of the CRLs and the OCSP in real-time revocation scenarios of the authentication device 302 was measured. In the test scenario having 10,000 AI agents handling 500 transactions per second (TPS) for 60 minutes, resulted in average latency per transaction of 52.8 ms, a peak CPU utilization of 72.4%, a peak memory usage of 8.9 GB, a network throughput of 850 Mbps, 1.8 million transactions processed, and 0 failed transactions. Thus, authentication device 302 demonstrated excellent scalability, handling up to 10,000 AI agents with no failed transactions. The slight increase in average latency (from 48.6 ms to 52.8 ms) is expected due to the higher volume of concurrent transactions but remains within acceptable limits. The system maintained stable CPU and memory usage, indicating that the framework can scale effectively without significant performance degradation.

In an embodiment, the authentication device 302 may be integrated with emerging AI communication protocols, such as those used in distributed machine learning or federated learning environments. This integration could further enhance the security and efficiency of AI-driven systems. The authentication device 302 may also be integrated with blockchain technology to create a decentralized trust model. Blockchain could be used to store and verify certificates in a tamper-proof manner, reducing the reliance on centralized CAs.

In some embodiments, the authentication device 302 may be used for managing the lifecycle of certificates, including issuance, renewal, and revocation. The authentication device 302 may be used to predict when certificates are likely to be compromised and proactively renew or revoke them. The authentication device 302 may also be adapted for use in internet of things (IOT) environments, where secure communication between devices is critical. Edge computing scenarios, where devices communicate directly without centralized control, may particularly benefit from the decentralized nature of the authentication device 302.

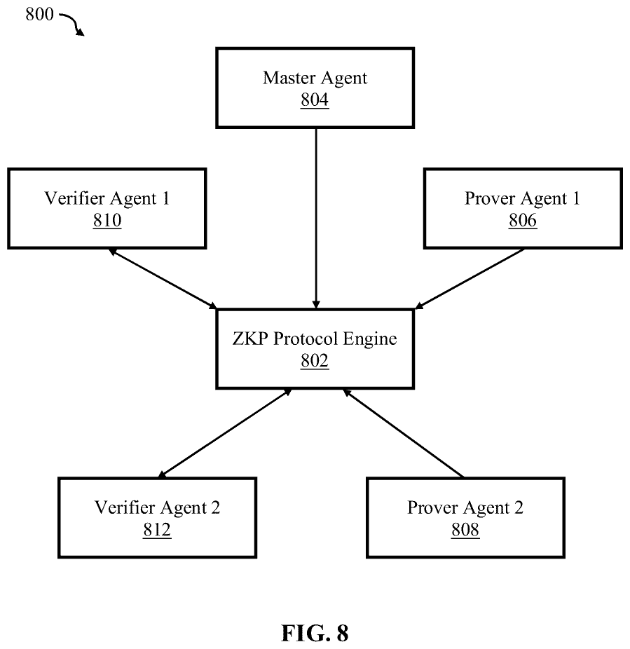

FIG. 8 illustrates a zero-knowledge proof (ZKP) authentication flow diagram 800 for ensuring authenticity and integrity of communications and interactions between autonomous agents, according to an embodiment. The ZKP authentication flow diagram 800 may include: a ZKP protocol engine 802, a master AI agent 804, a first prover agent 806, a second prover agent 808, a first verifier agent 810, and a second verifier agent 812.

Particularly, as illustrated by the ZKP authentication flow diagram 800, the master AI agent 804 may perform authentication by generating a ZKP using the ZKP protocol engine 802. The master agent 804 may be a central authority that authenticates itself to the other AI agents. The prover AI agents, particularly the first prover agent 806 and the second prover agent 808, transmit their identity or a validity proof to the ZKP protocol engine 802. Next, the ZKP and the prover agent identity or the validity proof may be transmitted to the verifier agents, particularly the first verifier agent 810 and the second verifier agent 812. The verifier agents use the ZKP Protocol Engine 802 to verify the ZKP based on the prover agent identity or the validity proof. Then, if the verification is successful, the verifier agents accept the identity of the master agent.

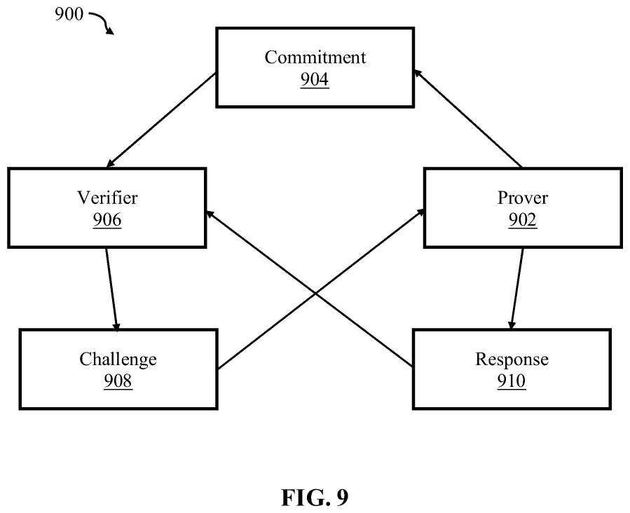

FIG. 9 illustrates a ZKP process diagram 900 for ensuring authenticity and integrity of communications and interactions between autonomous agents, according to an embodiment. The ZKP process diagram 900 illustrates a general overview of the ZKP process, according to an embodiment, and includes a commitment 902, a prover AI agent 904, a verifier AI agent 906, a challenge 908, and a response 910.

Particularly, as illustrated by the ZKP process diagram 900, a prover AI agent 902 computes a commitment 904. For example, the commitment 904 may be based on the formula \(t=g\hat{ }r \ mod p \), where \(g \) is a generator of a group with prime order \(p \), and \(r \) is a random number selected by the prover AI agent 902. The commitment 904 may then be sent to the verifier AI agent 906. The verifier AI agent 906 may then generate a challenge 908 that is transmitted to the prover AI agent 902. Next, the prover AI agent 902 may compute a response 910 to the challenge 908. For example, the prover AI agent 902 may compute \(s=r+c \cdot×\ mod (p−1) \) and sends \(s \) to the verifier, in response to a challenge \(c \). Then the verifier AI agent 906 may verify the response 910. For example, the AI agent 906 may verify if \(g\hat{ }s \ mod p=t \cdot y\hat{ }c \ mod p \), where \(y=g\hat{ }×\ mod p \) is the prover AI agent's 902 public key. The verifier AI agent 906 may verify the proof without gaining any additional or secure information.

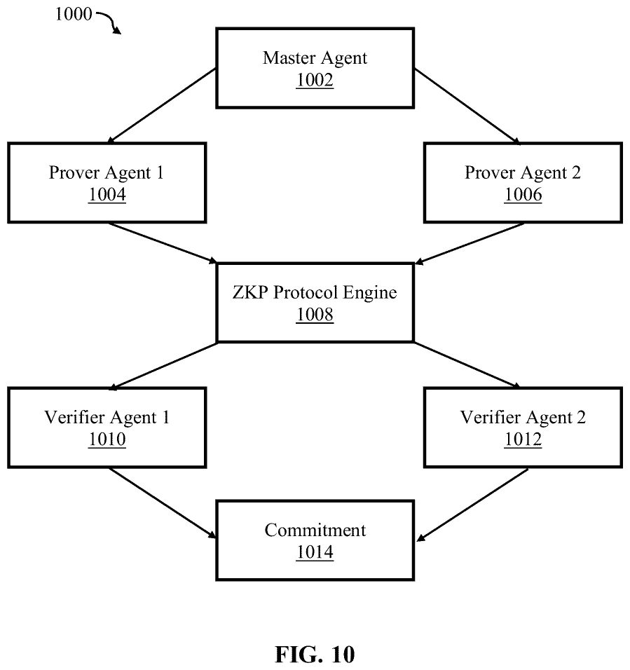

FIG. 10 illustrates a ZKP architecture diagram 1000 for ensuring authenticity and integrity of communications and interactions between autonomous agents, according to an embodiment. The ZKP architecture diagram 1000 illustrates the general architecture of AI agent authentication using ZKP, according to an embodiment, and includes a master AI agent 1002, a first prover AI agent 1004, a second prover AI agent 1006, a ZKP Protocol Engine 1008, a first verifier AI agent 1010, a second verifier AI agent 1012, and a commitment 1014.

Particularly, as illustrated by the ZKP architecture diagram 1000, a master AI agent 1002 is in communication with multiple prover agents, including the first prover AI agent 1004 and the second prover AI agent 1006. The master AI agent 1002 may authenticate itself with the first prover AI agent 1004 and the second prover AI agent 1006 by transmitting a master public key. The master public key, as well as a first prover public key from the first prover AI agent 1004 and a second prover public key from the second prover AI agent 1006 may be transmitted to the ZKP Protocol Engine 1008. The ZKP Protocol Engine 1008 may then generate the ZKP based on the received public keys and transmit the ZKP to a plurality of verifier AI agents, including the first verifier AI agent 1010 and the second verifier AI agent 1012. The first verifier AI agent 1010 and the second verifier AI agent 1012 checks the ZKP and may generate or authorize a commitment 1014 if the ZKP is verified.

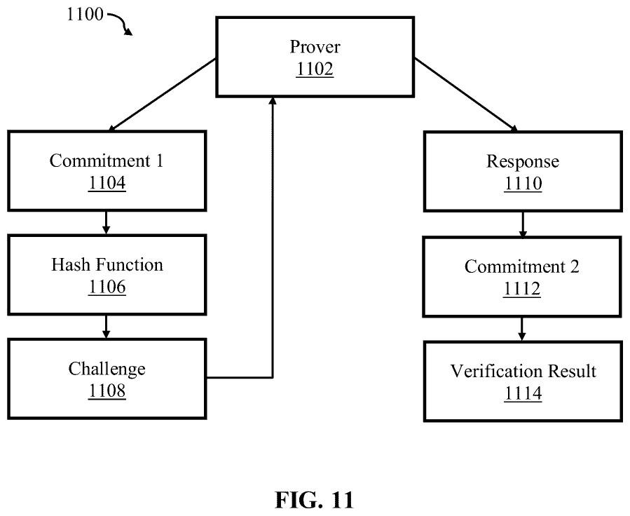

FIG. 11 illustrates a non-interactive ZKP flow diagram 1100 for ensuring authenticity and integrity of communications and interactions between autonomous agents, according to an embodiment. The non-interactive ZKP flow diagram 1100 illustrates an overview of the process and steps for authenticating AI agents using a non-interactive ZKP process, according to an embodiment, and includes a prover AI agent 1102, a first commitment (t) 1104, a hash function (H) 1106, a challenge (c) 1108, a response(s) 1110, a second commitment 1112, and a verification result 1114. This protocol may eliminate the need for back-and-forth communication by using a cryptographic hash function to generate the challenge.

Particularly, as illustrated by the non-interactive ZKP flow diagram 1100, a prover AI agent 1102 computes a first commitment (t) 1104. For example, the first commitment (t) 1104 may be based on the formula \(t=g\hat{ }r \ mod p \), where \(g \) is a generator of a group with prime order \(p \), and \(r \) is a random number selected by the prover AI agent 1102. The hash function (H) 1106 may then derive the challenge (c) 1108 from the first commitment (t) 1104. For example, the challenge \(c \) may be derived as \(c=H(y, t) \), where \(H \) is a cryptographic hash function. Based on the challenge (c) 1108, the prover AI agent 1102 computes a response(s) 1110. For example, the prover AI agent 1102 may compute \(s=r+c \cdot×\ mod (p−1) \). The response(s) 1110 may then be used as a second commitment 1112 that may be verified by anyone at anytime to generate the verification result 1114. For example, a verifier may check if \(g\hat{ }s \ mod p=t \cdot y\hat{ }c \ mod p \) to verify the second commitment 1112.

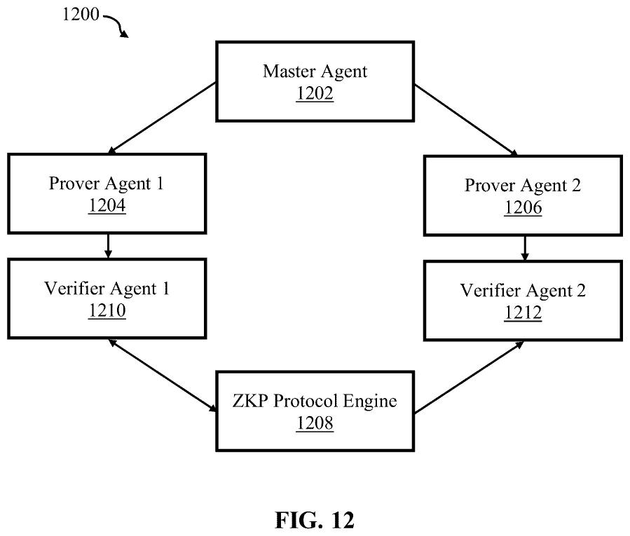

FIG. 12 illustrates a multi-agent ZKP authentication flow diagram 1200 for ensuring authenticity and integrity of communications and interactions between autonomous agents, according to an embodiment. The multi-agent ZKP authentication flow diagram 1200 illustrates an overview of the process and steps for authenticating agents using a process involving multiple agents, according to an embodiment, and includes a master AI agent 1202, a first prover AI agent 1204, a second prover AI agent 1206, a ZKP Protocol Engine 1208, a first verifier AI agent 1210, and a second verifier AI agent 1212.

Particularly, as illustrated by the ZKP architecture diagram 1200, a master AI agent 1202 is in communication with multiple prover agents, including the first prover AI agent 1204 and the second prover AI agent 1206. The master AI agent 1202 may authenticate itself with the first prover AI agent 1204 and the second prover AI agent 1206 by transmitting a master public key. The master public key, as well as a first prover public key from the first prover AI agent 1204 may then be transmitted to the verifier AI agent 1210. And the master public key, as well as a second prover public key from the second prover AI agent 1206 may be transmitted to the second verifier AI agent 1212. The first verifier AI agent 1210 may then check and verify the identity of the first prover AI agent 1204 and the master AI agent 1202 with the ZKP protocol engine 1208. The second verifier AI agent 1212 may then check and verify the identity of the second prover AI agent 1206 and the master AI agent 1202 with the ZKP protocol engine 1208.

In an experimental setup, performance of the ZKP-based authentication system was evaluated using a simulated network of 100 AI agents, consisting of a mix of Prover and Verifier agents. The experimental setup included the following conditions: 1) Simulated Environment: a distributed AI system was simulated with 100 agents, each running on separate virtual machines to mimic a real-world distributed environment. The agents were randomly assigned roles as either Prover or Verifier agents. 2) System Load: the tests were conducted under varying levels of system load, including low, medium, and high traffic scenarios, to assess the system's robustness and scalability. And 3) Test Scenarios: the system was tested in different scenarios, including synchronous vs. asynchronous communication, single-agent authentication vs. multi-agent authentication, and varying levels of agent interaction complexity.

In the experimental setup the security results were evaluated. Regarding Resistance to Attacks: 1) Replay Attacks: the system was subjected to 10,000 replay attacks, where previously used authentication messages were replayed to trick the Verifier agents. The ZKP-based system successfully resisted 100% of these attacks, as the ZKP protocol ensures that each authentication proof is unique and cannot be reused. 2) MitM Attacks: the system was also tested against MitM attacks by intercepting and attempting to alter the communication between Prover and Verifier agents. The ZKP protocol's zero-knowledge property ensured that the attackers could not derive any useful information, resulting in a 0% success rate for the attacks. And 3) Brute-Force Attacks: a brute-force attack was simulated by attempting to guess the Prover's secret through random inputs. The system resisted these attacks with a 99.9999% success rate, with only 1 in 1,000,000 attempts succeeding, which is within the acceptable limits for cryptographic security.

Regarding Probability of False Positives: during the evaluation, the system processed 50,000 authentication attempts. Out of these, only 2 false positives were recorded, resulting in a false positive rate of 0.004%. This low rate indicates the system's high accuracy in correctly identifying and authenticating agents.

In the experimental setup the performance results were also evaluated. Regarding Computational Overhead: the computational overhead for ZKP operations was measured and compared to traditional public-key cryptography methods. The results showed that the ZKP-based system required approximately 15% less computational power, reducing the average CPU utilization from 60% to 51% during peak loads. This reduction is significant in distributed environments where resources are often limited. Memory usage was also evaluated, with the ZKP system consuming an average of 200 MB of RAM per agent, compared to 240 MB for traditional methods, representing a 16.7% reduction in memory overhead.

Regarding Scalability: the system's scalability was tested by gradually increasing the number of active agents from 10 to 100. The latency increase was minimal, rising from an average of 45 ms with 10 agents to 60 ms with 100 agents. This indicates that the system can scale effectively without significant performance degradation. The network bandwidth usage was also monitored. With 100 agents, the ZKP-based system used 20% less bandwidth compared to traditional methods due to the more efficient exchange of smaller, non-sensitive proofs rather than full cryptographic keys or token exchanges.

Regarding Latency: the average time taken to complete an authentication process in a distributed environment was 60 milliseconds. This is significantly lower than the 120 milliseconds recorded for traditional public-key methods. The reduction in latency is attributed to the streamlined communication process in ZKP, where fewer large data exchanges are required. In scenarios involving asynchronous communication, the latency remained consistent, with no significant increase observed, demonstrating the system's robustness in varied communication settings.

TABLE 1
Summary of Experimental Setup Performance Results.

| | ZKP-Based | | Traditional | | |
|---|---|---|---|---|---|
| Metric | System | | System | | Improvement |
| Replay Attack | 100% | | 85% | | +15% |
| Resistance | | | | | |
| MitM Resistance | 100% | | 90% | | +10% |
| Brute-Force Attack | 99.9999% | | 99.5% | | +0.4999% |
| Resistance | | | | | |
| False Positive Rate | 0.004% | | 0.02% | | −0.016% |
| CPU Utilization | 51% | | 60% | | −15% |
| (Peak Load) | | | | | |
| Memory Usage per | 200 | MB | 240 | MB | −16.7% |
| Agent | | | | | |
| Authentication | 60 | ms | 120 | ms | −50% |
| Latency | | | | | |

| | | | |
|---|---|---|---|
| Network Bandwidth | 80% of | 100% of | −20% |
| Usage | capacity | capacity | |

The results shown in Table 1 demonstrate that the ZKP-based system provides superior security and performance compared to traditional authentication methods. The 100% resistance to replay and MitM attacks, coupled with a near-perfect defense against brute-force attacks, highlights the robustness of ZKP in securing AI agent interactions. The reduction in computational overhead and latency, along with the improved scalability, suggests that ZKP is not only a secure alternative but also a more efficient one, making it ideal for large-scale AI systems where resources are at a premium. Compared to traditional systems, the ZKP-based authentication method offers significant improvements in both security and performance metrics. The lower false positive rate and reduced resource consumption indicate that ZKP is more reliable and less taxing on system resources, which is crucial for maintaining system stability in complex AI environments.

In an embodiment, ZKP may be implemented with blockchain technology, creating fully decentralized and secure AI networks. This integration may enable AI agents to authenticate each other without relying on a central authority, further enhancing security and privacy. In some embodiments, the authentication device 302 may include autonomous AI agents that can negotiate, collaborate, and authenticate each other without human intervention. In some embodiments, the authentication device 302 may be configured to ensure that AI systems are regulatory compliant by ensuring that no unnecessary data is shared during interactions.

In an embodiment, ZKP may be applied to secure patient data handling in AI-driven diagnostics and treatment recommendations, ensuring that sensitive medical information remains confidential during AI interactions. ZKP may also be used in fintech applications, particularly in enabling privacy-preserving AI transactions that protect users' financial information. Additionally, ZKP may be integrated into AI-driven smart contracts, enhancing security and privacy in automated agreements and transactions.

Accordingly, with this technology, an optimized process for ensuring authenticity and integrity of communications and interactions between autonomous agents is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for authenticating autonomous agent communications, the method being implemented by at least one processor, the method comprising:
receiving, by the at least one processor, a request to transmit information from a first autonomous artificial intelligence (AI) agent to a second autonomous AI agent;
generating, by the at least one processor, a first authentication factor for the second autonomous AI agent;
analyzing, by the at least one processor, the first authentication factor to determine whether an identity of the second autonomous AI agent is verifiable; and
when the determination is made that the identity of the second autonomous AI agent is verifiable, transmitting, by the at least one processor, the information from the first autonomous AI agent to the second autonomous AI agent.

2. The method of claim 1, further comprising:
generating, by the at least one processor, a second authentication factor for the first autonomous AI agent, by issuing, via a certificate authority, a first certificate that includes a first public key and first identifying information of the first autonomous AI agent,
wherein the generating of the first authentication factor comprises issuing, by the at least one processor via the certificate authority, a second certificate that includes a second public key and second identifying information of the second autonomous AI agent; and
analyzing, by the at least one processor, the second authentication factor to determine whether an identity of the second autonomous AI agent is verifiable,
wherein the analyzing of the second authentication factor comprises exchanging the first certificate with the second autonomous AI agent and determining, by the at least one processor via the certificate authority, whether the first certificate is valid, and
wherein the analyzing of the first authentication factor comprises exchanging the second certificate with the first autonomous AI agent and determining, by the at least one processor via the certificate authority, whether the second certificate is valid.

3. The method of claim 2, further comprising:
verifying, by the at least one processor via the certificate authority, a revocation status of the first certificate based on a certificate revocation list;
when the revocation status of the first certificate is listed as revoked, preventing, by the at least one processor, the transmitting of the information from the first autonomous AI agent to the second autonomous AI agent;
verifying, by the at least one processor via the certificate authority, a revocation status of the second certificate based on the certificate revocation list; and
when the revocation status of the second certificate is listed as revoked, preventing, by the at least one processor, the transmitting of the information from the first autonomous AI agent to the second autonomous AI agent.

4. The method of claim 2, further comprising:
determining, by the at least one processor, whether the first certificate is compromised;
when the first certificate is compromised, generating, by the at least one processor, a revocation request;
transmitting, by the at least one processor, the revocation request to the certificate authority;
determining, by the at least one processor, whether the second certificate is compromised;
when the second certificate is compromised, generating, by the at least one processor, a revocation request; and
transmitting, by the at least one processor, the revocation request to the certificate authority.

5. The method of claim 2, further comprising:
changing, by the at least one processor, the first public key at a predetermined interval; and
changing, by the at least one processor, the second public key at the predetermined interval.

6. The method of claim 1, further comprising:
wherein the generating of the first authentication factor includes generating, by the at least one processor, a zero-knowledge proof, and
wherein the analyzing of the first authentication factor comprises:
transmitting, by the at least one processor, a challenge to the second autonomous AI agent;
prompting, by the at least one processor, the second autonomous AI agent to compute a response to the challenge; and
prompting, by the at least one processor, the first autonomous AI agent to determine whether the computed response matches a key based on the generated zero-knowledge proof.

7. The method of claim 6, further comprising:
generating, by the at least one processor via a master AI agent, the zero-knowledge proof using a zero-knowledge proof protocol engine; and
transmitting, by the at least one processor, the zero-knowledge proof from the master AI agent to the first autonomous AI agent.

8. The method of claim 6, wherein the analyzing of the first authentication factor further comprises:
generating, by the at least one processor via a cryptographic hash function, the challenge; and
prompting, by the at least one processor, the second autonomous AI agent to compute a commitment proof,
wherein the computation of the response to the challenge is based on the commitment proof.

9. The method of claim 6, wherein the analyzing of the first authentication factor further comprises:
prompting, by the at least one processor, the second autonomous AI agent to select a first random value and compute a commitment proof based on the first random value;
transmitting, by the at least one processor, the challenge from the first autonomous AI agent to the second autonomous AI agent;
prompting, by the at least one processor, the second autonomous AI agent to compute the response to the challenge based on the commitment proof; and
transmitting, by the at least one processor, the response from the second autonomous AI agent to the first autonomous AI agent for the determining of whether the computed response matches the key based on the generated zero-knowledge proof.

10. A computing apparatus for authenticating autonomous agent communications, the computing apparatus comprising:
a processor;
a memory; and
a communication interface coupled to each of the processor and the memory,
wherein the processor is configured to:
receive, via the communication interface, a request to transmit information from a first autonomous artificial intelligence (AI) agent to a second autonomous AI agent;
generate a first authentication factor for the second autonomous AI agent;
analyze the first authentication factor to determine whether an identity of the second autonomous AI agent is verifiable; and
when the determination is made that the identity of the second autonomous AI agent is verifiable, transmit the information from the first autonomous AI agent to the second autonomous AI agent.

11. The computing apparatus of claim 10, wherein the processor is further configured to:
generate a second authentication factor for the first autonomous AI agent;
issue, via a certificate authority, a first certificate that includes a first public key and first identifying information of the first autonomous AI agent;
issue, via the certificate authority, a second certificate that includes a second public key and second identifying information of the second autonomous AI agent; and
analyze the second authentication factor to determine whether an identity of the second autonomous AI agent is verifiable,
wherein the analysis of the second authentication factor comprises exchanging the first certificate with the second autonomous AI agent and determining, via the certificate authority, whether the first certificate is valid, and
wherein the analysis of the first authentication factor comprises exchanging the second certificate with the first autonomous AI agent and determining, via the certificate authority, whether the second certificate is valid.

12. The computing apparatus of claim 11, wherein the processor is further configured to:
verify, via the certificate authority, a revocation status of the first certificate based on a certificate revocation list;
when the revocation status of the first certificate is listed as revoked, prevent the transmitting of the information from the first autonomous AI agent to the second autonomous AI agent;
verify, via the certificate authority, a revocation status of the second certificate based on the certificate revocation list; and
when the revocation status of the second certificate is listed as revoked, prevent the transmitting of the information from the first autonomous AI agent to the second autonomous AI agent.

13. The computing apparatus of claim 11, wherein the processor is further configured to:
determine whether the first certificate is compromised;
when the first certificate is compromised, generate a revocation request;
transmit the revocation request to the certificate authority;
determine whether the second certificate is compromised;
when the second certificate is compromised, generate a revocation request; and
transmit the revocation request to the certificate authority.

14. The computing apparatus of claim 11, wherein the processor is further configured to:
change the first public key at a predetermined interval; and
change the second public key at the predetermined interval.

15. The computing apparatus of claim 10, wherein the processor is further configured to:
generate a zero-knowledge proof;
transmit a challenge to the second autonomous AI agent;
prompt the second autonomous AI agent to compute a response to the challenge; and
prompt the first autonomous AI agent to determine whether the computed response matches a key based on the generated zero-knowledge proof.

16. The computing apparatus of claim 15, wherein the processor is further configured to:
generate, via a master AI agent, the zero-knowledge proof using a zero-knowledge proof protocol engine; and
transmit the zero-knowledge proof from the master AI agent to the first autonomous AI agent.

17. The computing apparatus of claim 15, wherein the processor is further configured to:
generate, via a cryptographic hash function, the challenge; and
prompt the second autonomous AI agent to compute a commitment proof,
wherein the computation of the response to the challenge is based on the commitment proof.

18. The computing apparatus of claim 15, wherein the processor is further configured to:
prompt the second autonomous AI agent to select a first random value and compute a commitment proof based on the first random value;
transmit the challenge from the first autonomous AI agent to the second autonomous AI agent;
prompt the second autonomous AI agent to compute the response to the challenge based on the commitment proof, and
transmit the response from the second autonomous AI agent to the first autonomous AI agent for the determining of whether the computed response matches the key based on the generated zero-knowledge proof.

19. A non-transitory computer readable storage medium storing instructions for authenticating autonomous agent communications, the storage medium comprising executable code which, when executed by a processor, causes the processor to:
receive a request to transmit information from a first autonomous artificial intelligence (AI) agent to a second autonomous AI agent;
generate a first authentication factor for the second autonomous AI agent;
analyze the first authentication factor to determine whether an identity of the second autonomous AI agent is verifiable; and
when the determination is made that the identity of the second autonomous AI agent is verifiable, transmit the information from the first autonomous AI agent to the second autonomous AI agent.

20. The storage medium of claim 19, wherein when executed by the processor, the executable code further causes the processor to:
generate a second authentication factor for the first autonomous AI agent;
issue, via a certificate authority, a first certificate that includes a first public key and first identifying information of the first autonomous AI agent;
issue, via the certificate authority, a second certificate that includes a second public key and second identifying information of the second autonomous AI agent; and
analyze the second authentication factor to determine whether an identity of the second autonomous AI agent is verifiable,
wherein the analysis of the second authentication factor comprises exchanging the first certificate with the second autonomous AI agent and determining, via the certificate authority, whether the first certificate is valid, and
wherein the analysis of the first authentication factor comprises exchanging the second certificate with the first autonomous AI agent and determining, via the certificate authority, whether the second certificate is valid.
